(19) United States
(12) Patent Application Publication
(10) Pub. No.: US 2018/0128200 A1
(43) Pub. Date: May 10, 2018

(54) SYSTEMS AND METHODS FOR CONTROLLING FLUID INJECTIONS

(71) Applicant: GM GLOBAL TECHNOLOGY OPERATIONS LLC, DETROIT, MI (US)

(72) Inventors: Yiran HU, Shelby Township, MI (US); Scott E. PARRISH, Farmington Hills, MI (US); Chen-fang CHANG, Bloomfield Hills, MI (US)

(21) Appl. No.: 15/348,388

(22) Filed: Nov. 10, 2016

(51) Int. Cl. F02D 41/40; F02M 51/06

(52) U.S. Cl. CPC F02D 41/40; F02M 51/0603

(57) ABSTRACT

A vehicle includes a combustion engine having at least one cylinder to burn a fuel and a fuel injector to selectively supply fuel to the cylinder. The vehicle also includes a controller programmed to issue a series of fuel pulse commands to actuate the fuel injector to supply a corresponding series of fuel pulses that sum to an aggregate target fuel mass. The controller also monitors a closed-loop feedback signal indicative of a change in an opening delay between an individual one of the series of fuel pulse commands and a responsive fuel pulse. The controller is further programmed to adjust a subsequent one of the series of fuel pulse commands to incorporate the change in opening delay.

### TECHNICAL FIELD

The present disclosure relates to controlling fluid pulse injections. More specifically, the disclosure is related to fuel injection for a combustion engine.

### INTRODUCTION

Electronic fuel injection may be used to regulate fuel delivery in internal combustion engines. Certain example fuel injectors can be solenoid-actuated or piezo-electric valve devices disposed at a fuel intake portion of an engine. The fuel injectors may be positioned to deliver pressurized fuel into a combustion chamber of an engine cylinder. Each injector may be energized during combustion cycles for a period of time (i.e., for an injection duration) based upon the engine operating conditions. Multiple fuel injection events can occur during each combustion cycle for each cylinder. The fuel mass and timing of the multiple injections influences the quality of combustion and the overall fuel efficiency.

### SUMMARY

A vehicle includes a combustion engine having at least one cylinder to burn a fuel and a fuel injector to selectively supply fuel to the at least one cylinder. The vehicle also includes a controller programmed to issue a series of fuel pulse commands to actuate the fuel injector to supply a corresponding series of fuel pulses that sum to an aggregate target fuel mass. The controller is also programmed to monitor a closed-loop feedback signal indicative of a change in an opening delay between an individual one of the series of fuel pulse commands and a responsive fuel pulse. The controller is further programmed to adjust a subsequent one of the series of fuel pulse commands to incorporate the change in opening delay.

In one example, a target opening delay is used such that a subsequent one of the series of fuel pulses occurs after a predetermined time following a preceding fuel pulse.

A method of providing closely-spaced fluid pulses through a solenoid-driven valve includes providing a pressurized fluid at an inlet of the valve driven by a solenoid and issuing a series of fluid pulse commands to cause the valve to supply a corresponding series of fluid pulses that sum to an aggregate target fluid mass. The method also includes measuring a voltage across the solenoid and determining a valve closing time of a preceding fluid pulse based on a rate of change of the voltage. The method further includes determining an opening delay of the preceding fluid pulse based upon the closing time. The method further includes adjusting at least one subsequent fluid pulse command based on the determined opening delay.

A fuel delivery system includes a solenoid-driven fuel injector in fluid flow communication with a pressurized fuel source. The fuel injector is configured to deliver fuel to at least one cylinder of a combustion engine. The fuel delivery system also includes a controller programmed to issue a series of fuel pulse commands to cause the fuel injector to supply a corresponding series of pressurized fuel pulses that sum to an aggregate target fuel mass. The controller is also programmed to monitor for a change in an opening delay between an individual one of the series of fuel pulse commands and a responsive fuel pulse. The controller is further programmed to adjust a subsequent one of the series of fuel pulse commands to incorporate the change in opening delay.

### BRIEF DESCRIPTION OF THE DRAWINGS

FIG. 1 is a schematic view of a combustion engine.

FIG. 2 is a plot of rate of change of voltage across a fuel injector versus time.

FIG. 3A is plot of fuel pulse command and actual fuel pulse versus time for a reference fuel injector.

FIG. 3B is plot of fuel pulse command and actual fuel pulse versus time with adjustment for a subsequent fuel pulse opening delay.

FIG. 4 is a plot of fuel injector closing time versus fuel pulse quantity.

FIG. 5 is a plot of fuel injector closing time versus fuel pulse width command.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

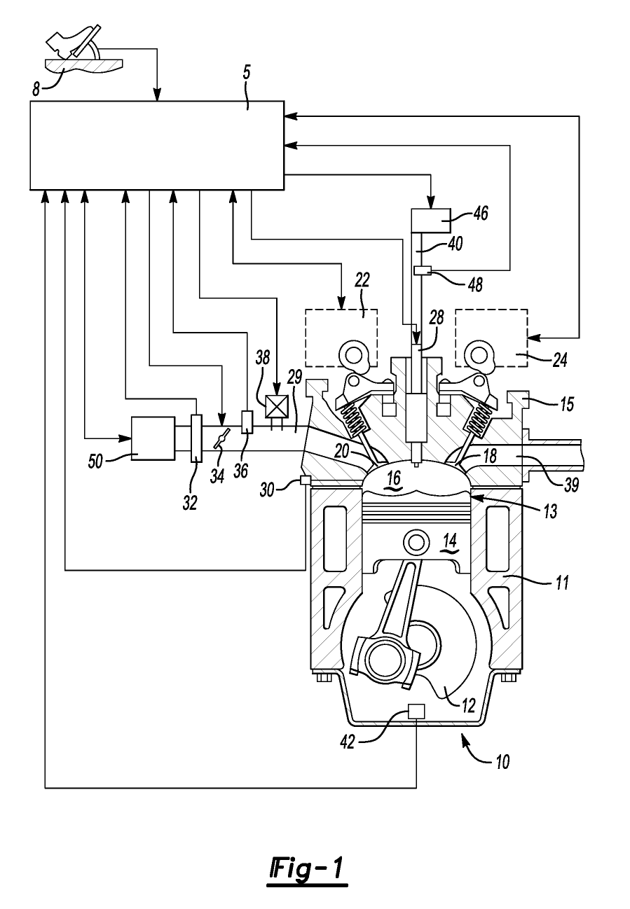

Referring to FIG. 1, an internal combustion engine 10 outputs torque as part of a vehicle propulsion system. The engine 10 may be selectively operative in a plurality of combustion modes, including auto-ignition combustion modes and a spark-ignition combustion modes. Intake air is mixed with a combustible fuel and burned within a combustion chamber. The engine 10 may be selectively operated using a stoichiometric ratio of air to fuel. Under certain operating conditions the air-fuel ratio is deliberately adjusted to be either rich or lean relative to a stoichiometric mix. Aspects of the present disclosure may also be applied to various types of internal combustion engine systems and combustion cycles. The engine 10 is selectively coupled to a transmission to transmit tractive power through a driveline of the vehicle to at least one road wheel. The transmission can include a hybrid transmission including additional propulsion sources to provide supplemental tractive power to the driveline.

Engine 10 may be a multi-cylinder, direct-injection, four-stroke internal combustion engine having at least one reciprocating piston 14 that is slidably movable within a cylinder 13. It should be appreciated that the systems and methods of the present disclosure may equally apply to different combustion cycles, for example such as those corresponding to two-stroke combustion engines. Movement of the piston 14 within a respective cylinder 13 provides a variable volume combustion chamber 16. Each piston 14 is connected to a rotating crankshaft 12 which translates linear reciprocating motion into rotational motion to rotate a driveline component.

An air intake system provides intake air to an intake manifold 29 which directs and distributes air to the combustion chambers 16. The air intake system may include airflow ductwork and devices for monitoring and controlling the airflow. The air intake system may also include a mass airflow sensor 32 for monitoring mass airflow and intake air temperature. An electronically-controlled throttle valve 34 may be used to control airflow to the engine 10. A pressure sensor 36 in the intake manifold 29 may be provided to monitor manifold absolute pressure and barometric pressure. An external flow passage (not shown) may also be provided to recirculate exhaust gases from engine exhaust back to the intake manifold 29. The flow of the recirculated exhaust gases may be regulated by an exhaust gas recirculation (EGR) valve 38. The engine 10 can include other systems, including a turbocharger system 50, or alternatively, a supercharger system to pressurize the intake air delivered to the engine 10.

Airflow from the intake manifold 29 to the combustion chamber 16 is regulated by one or more intake valves 20. Exhaust flow leaving of the combustion chamber 16 to an exhaust manifold 39 is regulated by one or more exhaust valves 18. The opening and closing of the intake and exhaust valves 20, 18 can be controlled and adjusted by controlling intake and exhaust variable lift control devices 22 and 24, respectively. The intake and exhaust lift control devices 22 and 24 may be configured to control and operate an intake camshaft and an exhaust camshaft, respectively. The rotations of the intake and exhaust camshafts 21 and 23 are mechanically linked and indexed to the rotation timing of the crankshaft 12. Thus the opening and closing of the intake and exhaust valves 20, 18 is coordinated with the positions of the crankshaft 12 and the pistons 14.

The variable lift control devices 22, 24 may also include a controllable mechanism to vary the magnitude of valve lift, or opening, of the intake and exhaust valve(s) 20 and 18, respectively. The lift magnitude may be varied according to discrete steps (e.g. high lift or low lift) or continuously varied. The valve lift position may be varied according to the operating conditions of propulsion system, including the torque demands of the engine 10. The variable lift control devices 22, 24 may further include a variable cam phasing mechanism to control and adjust phasing (i.e., relative timing) of opening and closing of the intake valves 20 and the exhaust valves, 18 respectively. Phase adjustment includes shifting opening times of the intake and exhaust valves 20, 18 relative to positions of the crankshaft 12 and the piston 14 in the respective cylinder 15.

The variable lift control devices 22, 24 each may be capable of a range of phasing of about 60-90 degrees relative to crank rotation, to permit advancing or retarding the opening and closing of one of intake and exhaust valves 20, 18 relative to position of the piston 14 for each cylinder 15. The range of phasing is defined and limited by the intake and exhaust variable lift control devices 22, 24, which include camshaft position sensors to determine rotational positions of the intake and the exhaust camshafts. Variable lift control devices 22, 24 may be actuated using one of electro-hydraulic, hydraulic, and electric control force, controlled by the controller 5.

The engine 10 also includes a fuel injection system including a plurality of high-pressure fuel injectors 28 each configured to directly inject a predetermined mass of fuel into one of the combustion chambers 16 in response to a signal from the controller 5. While a single fuel injector is depicted in FIG. 1 for illustration purposes, the propulsion system may include any number of fuel injectors according to the number of combustion cylinders. The fuel injectors 28 are supplied pressurized fuel from a fuel distribution system through a fuel rail 40. A pressure sensor 48 monitors fuel rail pressure within the fuel rail 40 and outputs a signal corresponding to the fuel rail pressure to the controller 5.

The fuel distribution system also includes a high-pressure fuel pump 46 to deliver pressurized fuel to the fuel injectors 28 via the fuel rail 40. For example, the high-pressure pump 46 may generate fuel pressure delivered to the fuel rail 20 at pressures up to about 5,000 psi. In some examples, even higher fuel pressures may be employed. The controller 5 determines a target fuel rail pressure based on an operator torque request and engine speed, and the pressure is controlled using fuel pump 46. In one example, the fuel injector 28 includes a solenoid-actuated device to open a nozzle to inject fuel. However it is contemplated that aspects of the present disclosure may also apply to a fuel injector that utilizes a piezoelectric-actuated device or other types of actuation to distribute fuel. The fuel injector 28 also includes a nozzle placed through an opening in the cylinder head 15 to inject pressurized fuel into the combustion chamber 16. The nozzle of the fuel injector 28 includes a fuel injector tip characterized by a number of openings, a spray angle, and a volumetric flow rate at a given pressure. An exemplary fuel injector nozzle may include an 8-hole configuration having a 70 degree spray angle and a flow rate of 10 cc/s at about 1,450 psi.

Each fuel injector may include a pintle portion near a tip of the nozzle. The pintle interfaces with the nozzle to restrict or cutoff fuel flow when biased against an orifice. When the fuel injector is activated using energy supplied from a power source, a solenoid responds to the energy and actuates the pintle, lifting it away from the orifice to allow the high-pressure fuel to flow through. Fuel flows around the pintle and is ejected through the openings near the tip of the nozzle to spray into the combustion cylinder 16 to mix with air to facilitate combustion. A spark-ignition system may be provided such that spark energy is supplied to a spark plug for igniting or assisting in igniting cylinder charges in each of the combustion chambers 16 in response to a signal from the controller 5.

A series of multiple pintle lifts, or fuel pulses, may occur in rapid succession to obtain an optimal combustion condition without over-saturating the combustion cylinder. For example, a single longer pulse to achieve a desired target fuel mass may cause a larger than optimal depth of spray penetration into the cylinder. In contrast, multiple smaller pulses in succession that aggregate to a target fuel mass may have less overall penetration into the cylinder and create a more desirable combustion condition that results in better fuel economy and reduced emissions (e.g., particulates).

The controller 5 issues fuel pulse width (FPW) commands to influence the duration over which the injector is held open allowing fuel to pass. The fuel injectors may operate in both of linear and non-linear regions of fuel mass delivery with respect to injection duration. Linear regions of fuel mass delivery include commanded injection durations, having corresponding known and unique fuel mass deliveries at a given fuel pressure. Linear regions of fuel mass delivery include regions where fuel mass delivery increases monotonically with increased injection durations at constant fuel pressure. However non-linear regions of fuel mass delivery include commanded injection durations having unknown or unpredictable fuel mass deliveries at a given fuel pressure, including non-monotonic regions where the fuel injector can deliver the same fuel mass quantity at different injection durations. Boundaries of the linear and non-linear regions may vary for different fuel injector systems.

The engine 10 is equipped with various sensing devices for monitoring engine operation, including a crank sensor 42 capable of outputting RPM data and crankshaft rotational position. A pressure sensor 30 outputs a signal indicative of in-cylinder pressure which is monitored by controller 5. The pressure sensor 30 can include a pressure transducer that translates the in-cylinder pressure level to an electric signal. The pressure sensor 30 monitors in-cylinder pressure in real-time, including during each combustion event. An exhaust gas sensor 39 is configured to monitor exhaust gases, typically an air/fuel ratio sensor. Output signals from each of the combustion pressure sensor 30 and the crank sensor 42 are monitored by the controller 5 which determines combustion phasing, i.e., timing of combustion pressure relative to the crank angle of the crankshaft 12 for each cylinder 13 for each combustion event. Preferably, the engine 10 and controller 5 are mechanized to monitor and determine states of effective pressure for each of the engine cylinders 13 during each cylinder firing event. Alternatively, other sensing systems can be used to monitor states of other combustion parameters within the scope of the disclosure, e.g., ion-sense ignition systems, and non-intrusive cylinder pressure sensors.

Control module, module, controller, processor and similar terms used herein mean any suitable device or various combinations of devices, including Application Specific Integrated Circuit(s) (ASIC), electronic circuit(s), central processing unit(s) (preferably including microprocessors), and associated memory and storage (read only, programmable read only, random access, hard drive, etc.) executing one or more software or firmware programs, combinational logic circuit(s), input/output circuit(s) and devices, appropriate signal conditioning and buffer circuitry, and other suitable components to provide the described functionality. The controller 5 includes a set of control algorithms, including resident software program instructions and calibrations stored in memory and executed to provide desired functions. The algorithms are preferably executed during preset loop cycles. Algorithms are executed, such as by a central processing unit, and are operable to monitor inputs from sensing devices and other networked control modules, and execute control and diagnostic routines to control operation of actuators. Loop cycles may be executed at regular intervals during ongoing engine and vehicle operation. Alternatively, algorithms may be executed in response to occurrence of one more event observed by the controller.

The controller 5 is also programmed to control the throttle valve 34 to control mass flow of intake air into the engine via a control signal. In one example, the throttle valve 34 is commanded to wide open throttle to control manifold pressure by modifying both an intake air quantity and a recirculated exhaust gas quantity. The turbocharger system 50 preferably includes a variable geometry turbine (VGT) device. The controller 5 sends a signal to direct the angle of vanes of the VGT device. The angle of the vanes is measured with a VGT position sensor to provide feedback control to the controller 5. The controller 5 regulates the level of pressure boost thereby controlling the intake air quantity and the recirculated exhaust gas quantity. In other examples, a supercharger system can be utilized to modify the manifold pressure in analogous fashion.

The controller 5 is further programmed to control quantity exhaust gas recirculation by controlling opening of the exhaust gas recirculation valve 38. By controlling the opening of the exhaust gas recirculation valve 38, the controller 5 regulates the recirculated exhaust gas rate and the ratio of exhaust gas quantity to intake gas quantity.

The controller 5 is further programmed to command a start of injection (SOI) corresponding to position of the piston 14 based on input from the crank sensor 42 during ongoing operation of the engine 10. The controller 5 causes a fuel injection event using the fuel injector 28 for each combustion event for each cylinder 13. Injection events may be defined by injector open pulse duration and injected fuel mass. In at least one example, the controller 5 commands a plurality of successive fuel injections during each combustion event. The aggregate fuel mass delivered during each combustion event is selected by the controller 5 based at least on the operator torque request. The controller 5 monitors input signals from the operator, for example, through a position of an accelerator pedal 8 to determine the operator torque request. The controller 5 issues commands to operate the fuel injector to supply a series of fuel pulses that sum to an aggregate target fuel mass.

As discussed above, applying multiple fuel pulses in close succession may cause effects on subsequent pulses due to residual energy remaining in the fuel injector as well as residual armature motion from earlier pulses. In some examples, the controller 5 may employ feedback from monitored signals indicative of system operation. Closed-loop control of fuel injectors may rely on determining an opening delay to be estimated for each injector. Methods based solely on opening magnitude have limitations in certain situations. Correctly measuring the opening delay can be difficult in real time.

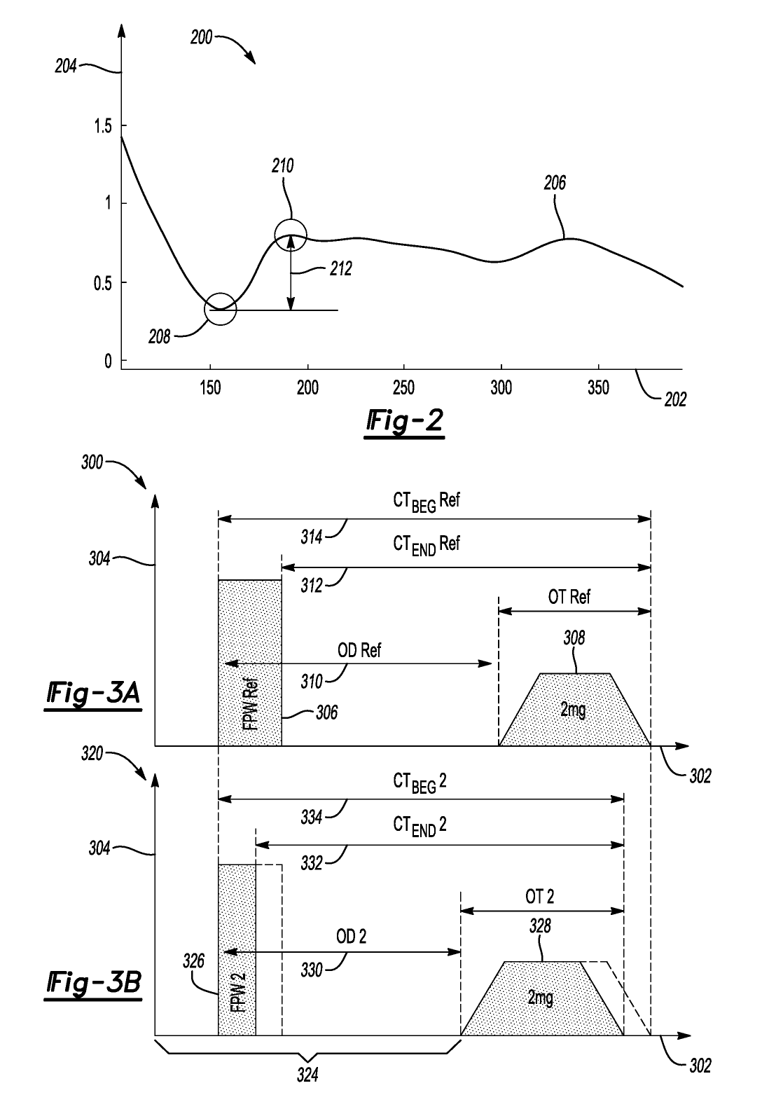

A voltage signal from each fuel injector may be monitored to indicate fuel injector performance. More specifically, the derivative, or rate of change dV/dt of the voltage is used to demarcate timing of certain events related to fuel injector actuation. Referring to FIG. 2, plot 200 depicts a profile of rate of change of injector voltage, dV/dt. Horizontal axis 202 represents time in μs. Vertical axis 204 represents rate of change of a voltage across the injector in volts per second (V/s). Curve 206 represents a profile of a rate of change of injector voltage during a fuel pulse. Certain features of the dV/dt profile correspond to key events during the injection pulse. A local minimum at about location 208 correlates to a point in time when the injector pintle closes. The voltage may be monitored by the controller for indications of valve closing time in response to issuance of the PWM command. The closing time CT is the duration of time from the PWM command (may be measured from the beginning or the end of the command) to the conclusion of a single fuel pulse event. An adjacent local maximum at about location 210 corresponds to a voltage spike following the closing of the valve. As discussed above, residual voltage following the pulse requires time to dissipate. The change in dv/dt between the local minimum at about location 208 and the local maximum at about location 210 correlates to the opening magnitude of the valve. More specifically, the controller may calculate the valve lift height, or opening magnitude OM, based on the magnitude 212 of the change of dV/dt. That is, the dv/dt magnitude of change 212 from the local minimum to the next local maximum correlates to the opening magnitude. The opening magnitude OM is correlated with amount of metered fuel in the ballistic region and can be used to indirectly determine injector opening delay for certain conditions. Both the closing time CT and opening magnitude OM can be directly measured form voltage profile dv/dt. Discussed in more detail below, measurement of fuel injector closing time CT can be incorporated to provide a more robust estimation and overcome some of the limitations of using OM alone.

Additional operating factors may reduce accuracy and/or precision of subsequent closely-spaced fuel injection pulses. For example, the variation of mechanical and electrical components within each injector can cause substantial quantity variations from injector to injector (for the same design/model of the injectors) even when open loop control is applied. Injection quantity has high correlation with the opening time of the injection. This relationship holds true for both single and multiple injection scenarios. Note that the opening time for an injection is defined as the amount of time that fuel is actually flowing through the injector. As such, a closed-loop control can be used to control each injection to a desired quantity by controlling the opening time of the injection to a desired opening time, which is characterized offline based on a set of reference injectors. Individual injectors are different from a set of reference injectors upon which the injector calibrations are based.

Opening time is controlled by modifying the pulse width command of the injection. As discussed in more detail below, opening time is calculated as the difference between the closing time and the opening delay of each injection. Closing time can be measured for each injection using the injector residual voltage. Under certain operating conditions, CT and OM are used to estimate the deviation of the opening delay OD of a particular injector from a reference injector.

FIG. 3A includes plot 300 which depicts operating characteristics of a master sample fuel injector baseline pulse. Horizontal axis 302 represents time and vertical axis 304 represents the presence of a command signal and a subsequent injector response. A FPW command 306 is provided to cause a fuel mass 308 (e.g., 2 mg) to pass through the injector in response. A reference opening delay OD_{Ref} 310 represents a lag from the initiation of the FPW command 306 and the actual opening of the solenoid valve. Similarly, a reference closing time CT_{End Ref} 312 represents the time duration between the end of the FPW command 306 and the actual closing of the solenoid valve at the end of the fuel pulse. Also, a reference closing time CT_{Beg Ref} is the measured time between the beginning of the FPW command and the actual solenoid closing. The closing time referenced from the beginning of the FPW may be less sensitive to the width of the command. On the other hand, the closing time referenced from the end of the FPW command may have a better correlation to the injected fuel quantity. Discussed in more detail below, the closing times measured from each of the beginning of the FPW command versus the end of the FPW command indicate different injector attributes with respect to making determinations of the opening delay. According to some examples, closing time duration is referenced from an end of the FPW command and used to make adjustments to subsequent pulses.

The opening time OT of the fuel pulse is characterized by equation 1 below.

OT_{Ref}=CT_{Beg Ref}−OD_{Ref} (1)

In order to obtain a closely-spaced subsequent fuel pulse having a predictable fuel mass the characteristics of the commanded subsequent fuel pulse may be adjusted based on both the dwell time following the preceding pulse and the fuel mass of the preceding pulse. The controller is also programmed to monitor real-time changes in the opening delay based on deviations from a reference opening delay duration measured from a reference fuel injector. The controller may also determine changes in opening delay by comparing real-time opening delay values against opening delay values of preceding pulses.

FIG. 3B includes plot 320 which depicts a fuel pulse from an injector with different opening delay characteristics as compared with the reference injector. The actual opening delay OD₂ 330 of the injector under a given operating condition may be based both on predetermined calibration values (feedforward control) as well as real-time OD learning based on the operating conditions (feedback control). Due to the difference in opening delay as compared to the reference injector, a different FPW command 326 may be required to obtain a predictable fuel mass 328.

According to another aspect of the present disclosure, the FPW command 326 of the subsequent pulse is modified in duration to control the actual open time OT₂ of the fuel injector, given by equation 2 below.

OT₂=CT_{Beg 2}−OD₂ (2)

The FPW command of the subsequent fuel pulse is adjusted until the OT₂ substantially equals the desired OT_{Ref}, which corresponds to a desired quantity. In other words, the subsequent pulse fuel mass may be controlled through feedback control of the FPW command duration. In some examples, closed-loop feedback signals indicative of operating conditions of preceding pulses are used to control the opening time of one or more subsequent injection pulses. In a more specific example, a signal indicative of the residual voltage in the injector solenoid is received at the controller. The controller may in turn modify one or more parameters of a subsequent pulse based on the residual voltage remaining in the solenoid following the preceding FPW command. As discussed above, the residual voltage signal may provide several key parameters for a given injection pulse, including CT and OM.

While the term “subsequent” is used in the present disclosure to describe a fuel pulse, it should be understood that an FPW command for any given pulse may be adjusted based on earlier pulse performance differences from calibrated values. There may be several causes for the opening delay of a particular injection on a particular injector to vary from the “nominal” calibrated value. One such cause is injector-to-injector variation, which may cause some degree of inaccuracy for all injections (i.e., single injections as well as multiple injections). In particular, small quantity injections are highly sensitive to the FPW commands. Thus, real-time FPW command adjustments for a given fuel injector may be based on any number of earlier pulse responses of the same injector—even for a single pulse.

In the examples of FIG. 3A and FIG. 3B, the desired fuel pulses yield a uniform fuel mass of 2 mg. However, it should be appreciated that different fuel mass quantities may be targeted to deliver non-uniform fuel pulses such that the subsequent pulses provide more or less fuel mass to enhance combustion properties. According to an example, the controller adjusts a duration of a subsequent FPW command (originally sized according to a target opening delay) to incorporate the change in opening delay such that the subsequent fuel pulse is timed according to the target opening delay following the preceding fuel pulse.

A calculated opening magnitude OM based on the residual voltage may correlate with injection quantity in certain parts of ballistic region. This can be particularly true for ballistic injections that are not closely-spaced to preceding injections—that is, those injections that are sufficiently spaced from the previous injection (e.g., dwell of 1000 μs or above). For such injections, CT measurements may be used to infer the opening delay OD of the injection. As described previously, the opening time OT of an injection is strongly correlated with the injection quantity even considering injector-to-injector variation. For ballistic injections where OM also carries good correlation with the injection quantity, this translates to an additional correlation between OM and the opening time OT. In other words, for such ballistic injections on two different injectors, if the measured OM is the same, the quantity injected will also be substantially the same, and the opening time OT for both cases will therefore be the same. This relationship allows the deviation of OD to be computed using the CT measurement. According to at least one example, the controller is programmed to sense a change in the opening delay OD of a subsequent pulse by monitoring the closing time duration CT between an individual one of the series of FPW commands and a corresponding responsive fuel pulse. These CT data are monitored as closed-loop feedback signals indicative of changes in OD and used to adjust one or more subsequent pulses.

This concept is made apparent from the plots of FIGS. 3A and 3B, with plot 300 representing a reference injector. The deviation of opening delay for the injector of plot 320 (denoted by ΔOD) from the reference injector is given by equation 3 below.

ΔOD=OD₂−OD_{ref} (3)

Since injected quantity is the same in between plot 300 and plot 320, the correlation between opening time and quantity requires that OT_{Ref} is substantially equal to OT₂. Using equations 1, 2, and 3, ΔOD can be expressed by equation 4 below.

ΔOD=CT_{Beg2}−CT_{BegRef} (4)

In other words, the difference between the closing time for the reference injector and the closing time measured for the same OM is the change in opening delay.

As mentioned previously, OM may generally correlate to fuel mass only for longer-spaced subsequent pulses following a greater dwell time (e.g., dwell ≥1000 μs). When dwell is less than a particular threshold, the OM correlation to fuel mass may deviate and as such the previously described method for calculating OD is less reliable. Instead, a different opening delay estimation strategy may be used that also incorporates the closing time measurement but in a different way.

In parts of the ballistic region of fuel injector pulse control, the closing time measured from the end of pulse width command carries good correlation with quantity of fuel injected. Thus CT may be used as a proxy for determining OD.

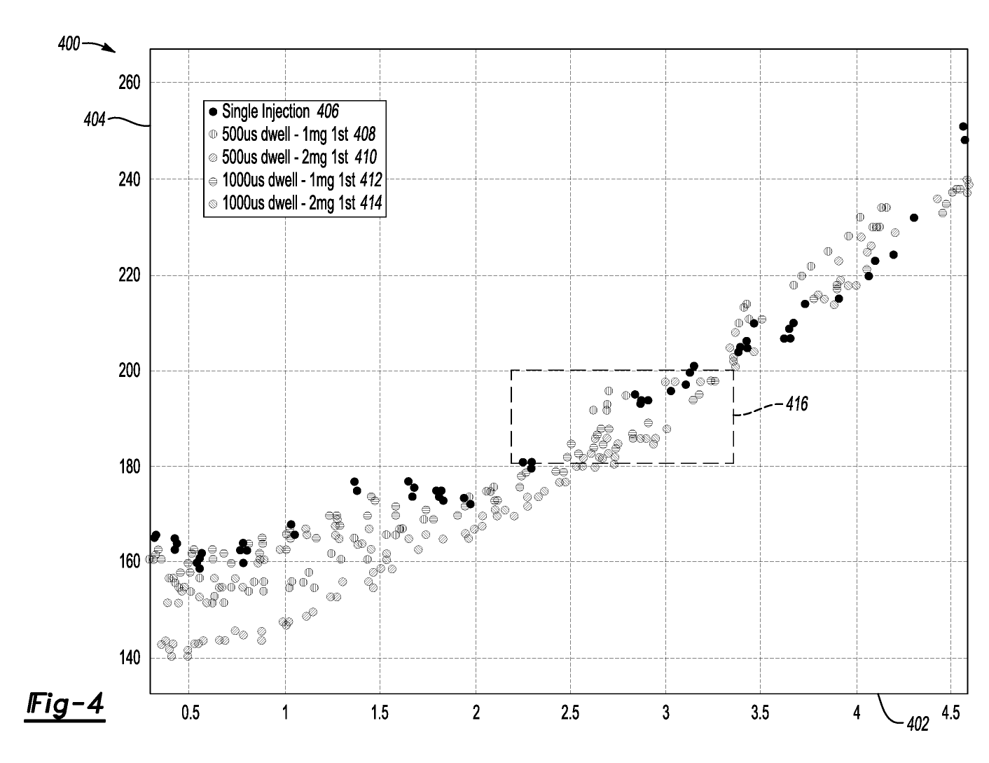

Referring to FIG. 4, plot 400 depicts the relationship between closing time CT and fuel quantity. Horizontal axis 402 represents fuel quantity in mg. Vertical axis 404 represents closing time measured from the end of the FPW command in μs. Curve 406 represents closing time a profile for a single injection. Curves 408 and 410 correspond to a dwell time of 500 μs following a 1 mg and a 2 mg preceding pulse, respectively. Curves 412 and 414 correspond to a dwell time of 1000 μs following a 1 mg and a 2 mg preceding pulse, respectively. In the example zone 416 there is a generally strong correlation between closing time and fuel quantity.

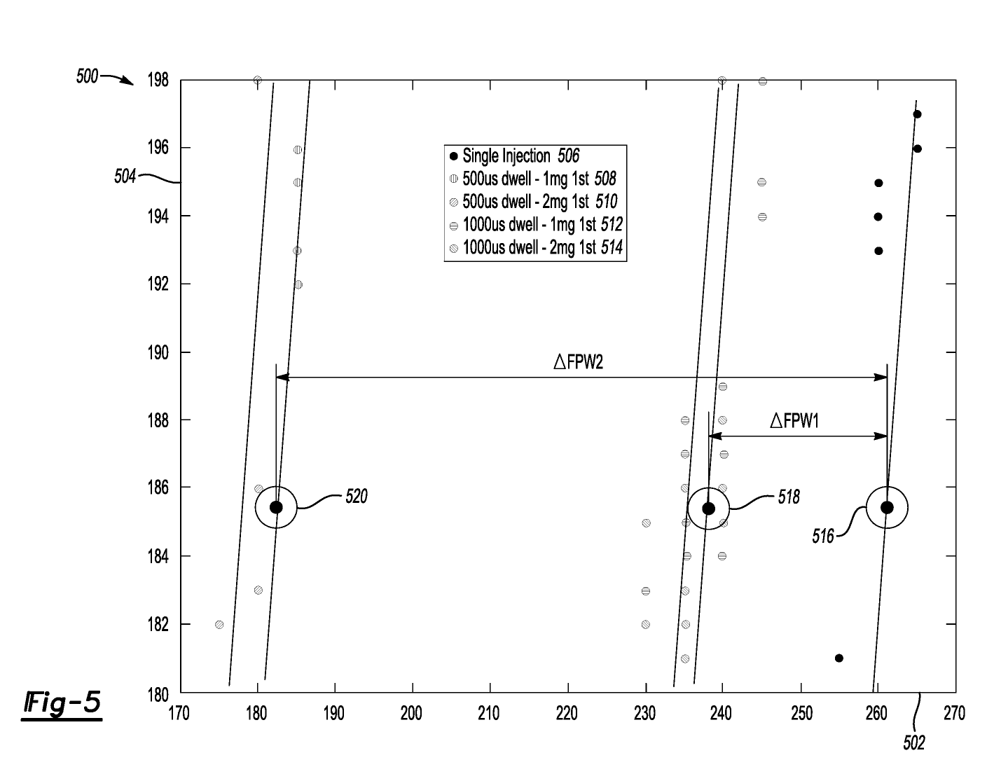

FIG. 5 includes plot 500 which provides a closer view of data corresponding to zone 416 of plot 400. Horizontal axis 502 corresponds to a duration of FPW Command in μs. Vertical axis 504 represents closing time measured from the end of the FPW command in μs. Similar to plot 400, curve 506 represents closing time a profile for a single injection. Curves 508 and 510 correspond to a dwell time of 500 μs following a 1 mg and a 2 mg preceding pulse, respectively. Curves 512 and 514 correspond to a dwell time of 1000 μs following a 1 mg and a 2 mg preceding pulse, respectively. The change in the FPW command due to the dwell time from the preceding pulse and the fuel mass of the preceding pulse is substantially the same as the opening delay OD. Referring to the example of plot 500, the change in the FPW command between location 516 of a single injection and location 518 of a subsequent pulse having a 1,000 μs dwell is reduced by about 25 μs. The reduction in the FPW command denoted by ΔFPW1 equals the reduction in the opening delay which is exhibited by the subsequent pulse. With continued reference to plot 500, the change in the FPW command between location 516 of a single injection and location 520 of a subsequent pulse having a 500 μs dwell is reduced by about 80 μs. The reduction in the FPW command denoted by ΔFPW2 equals the reduction in the opening delay which is exhibited by the subsequent pulse. As discussed above, a more closely-spaced subsequent pulse may carry increased residual energy in the fuel injector shortening the opening delay. As a result greater compensation is required for faster opening time of more closely-spaced subsequent pulses.

In the example of plot 500, the opening delay OD associated with a subsequent pulse having a 1,000 μs dwell time following a 1 mg preceding pulse is reduced by about 25 μs versus the OD_{Ref} of the preceding pulse (i.e., ΔFPW1). Similarly, the opening delay OD associated with a subsequent pulse having a 500 μs dwell time following a 1 mg preceding pulse is reduced by about 80 μs versus the OD_{Ref} of the preceding pulse (i.e., ΔFPW2). This relationship remains in effect even when OM is not well correlated to the injection quantity.

It is further contemplated that the technique of using multiple closely-spaced injection events to control spray penetration may apply to any type of fast cycling fluid spray injectors that operate to spray fluid in a variety of applications not limited only to engine combustion chambers. Multiple successive injections may be used in numerous applications, such as, but not limited to urea injection used for diesel selective catalytic reduction (SCR) system, spray painting and other dispensing of liquid medications.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a combustion engine having at least one cylinder to burn a fuel;
a fuel injector to selectively supply fuel to the at least one cylinder; and
a controller programmed to
issue a series of fuel pulse commands to actuate the fuel injector to supply a corresponding series of fuel pulses that sum to a predetermined aggregate target fuel mass,
monitor a closed-loop feedback signal indicative of a change in an opening delay between an individual one of the series of fuel pulse commands and a responsive fuel pulse, and
adjust a subsequent one of the series of fuel pulse commands to incorporate the change in opening delay.

2. The vehicle of claim 1 wherein the controller is further programmed to adjust an initiation timing of the subsequent one of the series of fuel pulse commands.

3. The vehicle of claim 1 wherein the controller is further programmed to adjust a duration of the subsequent one of the series of fuel pulse commands.

4. The vehicle of claim 1 wherein the controller is further programmed to sense the change in the opening delay based on monitoring a closing time duration between the individual one of the series of fuel pulse commands and the responsive fuel pulse.

5. The vehicle of claim 1 wherein the controller is further programmed to sense the change in the opening delay based on monitoring an opening magnitude of the preceding pulse.

6. The vehicle of claim 4 wherein the closing time duration is based on a rate of change of a voltage associated with the fuel injector.

7. The vehicle of claim 4 wherein the closing time duration is referenced from an end of the FPW command.

8. The vehicle of claim 1 wherein the change in the opening delay is based on a reference opening delay duration measured from a reference fuel injector.

9. A method of providing closely-spaced fluid pulses through a solenoid-driven valve comprising:
providing a pressurized fluid at an inlet of the valve driven by a solenoid;
issuing a series of fluid pulse commands to cause the valve to supply a corresponding series of fluid pulses that sum to an aggregate target fluid mass;
measuring a voltage across the solenoid;
determining a valve closing time of a preceding fluid pulse based on a rate of change of the voltage;
determining an opening delay of a start of the preceding fluid pulse based upon the closing time; and
adjusting at least one later fluid pulse command based on the determined opening delay of the preceding fluid pulse.

10. The method of claim 9 wherein the closing time of the valve is further based on at least one of a fluid mass of the preceding pulse of the series of pulses and a dwell time following the preceding pulse.

11. The method of claim 9 wherein adjusting the at least one later fluid pulse command comprises adjusting an initiation timing of the later fuel pulse command.

12. The method of claim 9 wherein adjusting the at least one later fluid pulse command comprises adjusting a duration of the later fuel pulse command.

13. The method of claim 9 further comprising determining a valve opening magnitude of a subsequent pulse of the series of fuel pulses based on the rate of change of the voltage.

14. A fuel delivery system comprising:
a solenoid-driven fuel injector in fluid flow communication with a pressurized fuel source, the fuel injector configured to deliver fuel to at least one cylinder of a combustion engine; and
a controller programmed to
issue a series of fuel pulse commands to cause the fuel injector to supply a corresponding series of pressurized fuel pulses that sum to an aggregate target fuel mass,
monitor for a change in an opening delay between an individual one of the series of fuel pulse commands and a responsive fuel pulse, and
adjust a subsequent one of the series of fuel pulse commands to incorporate the change in opening delay such that a subsequent one of the series of fuel pulses occurs after a predetermined opening delay following the preceding fuel pulse.

15. The fluid delivery system of claim 14 the controller is further programmed to adjust an initiation timing of the subsequent one of the series of fuel pulse commands.

16. The fluid delivery system of claim 14 the controller is further programmed to adjust a duration of the subsequent one of the series of fuel pulse commands.

17. The fluid delivery system of claim 14 wherein the closing time duration is referenced from an end of the FPW command.

18. The fluid delivery system of claim 14 wherein the change in the opening delay is based on a reference opening delay duration measured from a reference fuel injector.

19. The fluid delivery system of claim 14 wherein the controller is further programmed to measure a valve opening magnitude of the subsequent one of the series of fuel pulses based on the rate of change of the voltage.
